(19) United States
(12) Patent Application Publication
(10) Pub. No.: US 2019/0362466 A1
(43) Pub. Date: Nov. 28, 2019

(54) CONTENT ADAPTIVE RENDERING

(71) Applicant: QUALCOMM Incorporated, San Diego, CA (US)

(72) Inventor: Dileep MARCHYA, Hyderabad (IN)

(21) Appl. No.: 15/986,737

(22) Filed: May 22, 2018

(51) Int. Cl. G06T 3/40; G06T 1/20

(52) U.S. Cl. CPC G06T 3/40; G06T 1/20

(57) ABSTRACT

A method, an apparatus, and a computer-readable medium for wireless communication are provided. In one aspect, an example method may include generating a first frame for display using a first layer generated at a first resolution. The method may include generating a second frame not for display using the first layer generated at a second resolution. The method may include scaling the second frame from the second resolution to the first resolution. The method may include comparing the first frame and the scaled second frame. The method may include determining an image quality metric based on the comparison of the first frame and the scaled second frame.

### FIELD

The present disclosure relates generally to content adaptive rendering.

### BACKGROUND

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes a plurality of processing stages that operate together to execute graphics processing commands/instructions and output a frame. A central processing unit (CPU) may control the operation of the GPU by issuing one or more graphics processing commands/instructions to the GPU. Modern day CPUs are typically capable of concurrently executing multiple applications, each of which may need to utilize the GPU during execution. A device that provides content for visual presentation on a display generally includes a graphics processing unit (GPU).

A GPU renders a frame for display. This rendered frame may be processed by a display processing unit (DPU) prior to being displayed. For example, the display processing unit may be configured to perform processing on one or more frames that were rendered for display by the GPU and subsequently output the processed frame to a display. The pipeline that includes the CPU, GPU, and DPU may be referred to as a display processing pipeline. The resolution at which the GPU renders frames for a particular application is static.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a first processing unit and a display processing unit. The display processing unit may be configured to: generate a first frame for display using a first layer generated at a first resolution. The first layer may be associated with a first application. The display processing unit may be configured to generate a second frame not for display using the first layer generated at a second resolution. The first resolution may be different from the second resolution. The display processing unit may be configured to scale the second frame from the second resolution to the first resolution. The first processing unit may be configured to compare the first frame and the scaled second frame. The first processing unit may be configured to determine an image quality metric based on the comparison of the first frame and the scaled second frame.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram that illustrates an example content generation and coding system in accordance with the techniques of this disclosure.

FIG. 1B illustrates an example of scaling before blending in accordance with the techniques described herein.

FIG. 1C illustrates an example of scaling after blending in accordance with the techniques described herein.

FIGS. 2A-2E illustrate an example flow diagram in accordance with the techniques described herein.

FIG. 3 illustrates an example flowchart of a method of content adaptive rendering in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, it is understood that the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and executed the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to graphical content or display content. In some examples, as used herein, the term “graphical content” may refer to a content generated by a processing unit configured to perform graphics processing. For example, the term “graphical content” may refer to a content generated by one or more processes of a graphics processing pipeline. In some examples, as used herein, the term “graphical content” may refer to a content generated by a graphics processing unit. In some examples, as used herein, the term “display content” may refer to content generated by a processing unit configured to perform displaying processing. In some examples, as used herein, the term “display content” may refer to a content generated by a display processing unit. In accordance with the techniques described herein, display content may be destined for display in some examples, and may not be destined for display in other examples. Otherwise described, display content may be generated for display in some examples, and display content may be generated that is not for display in other examples. Graphical content may be processed to become display content. For example, a graphics processing unit may output graphical content, such as a frame, to a buffer. A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a GPU) may provide content, such as a frame, to a second component (e.g., a DPU). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

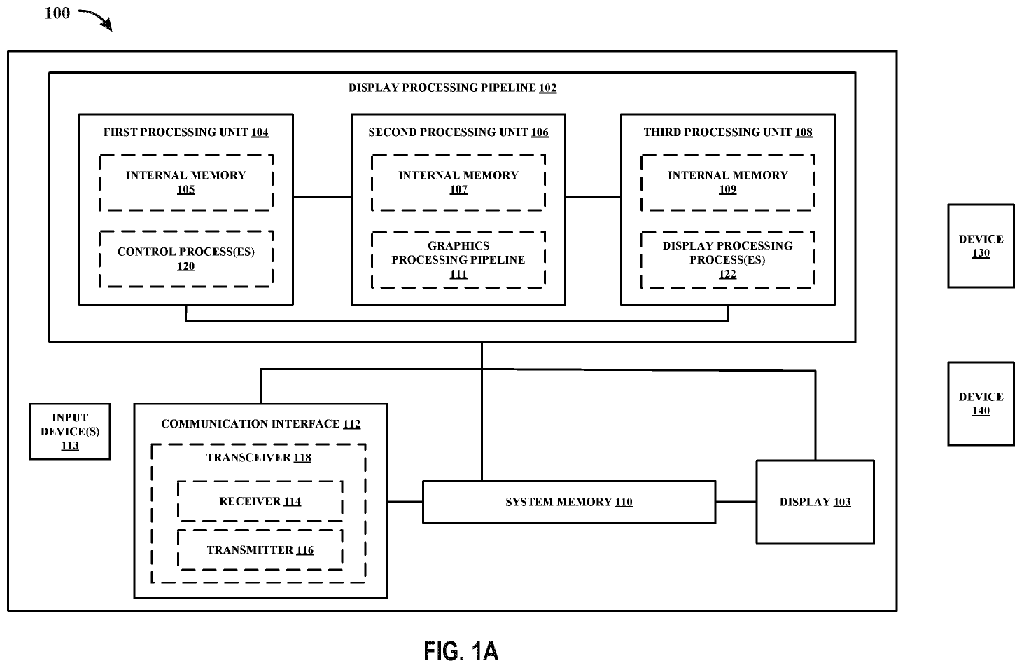

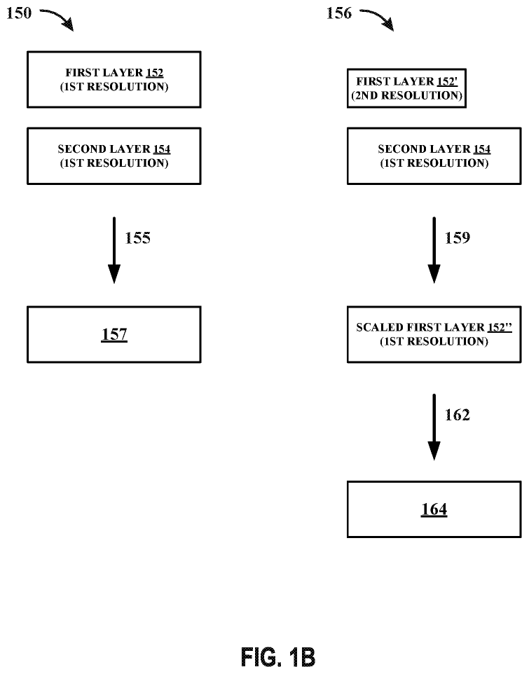

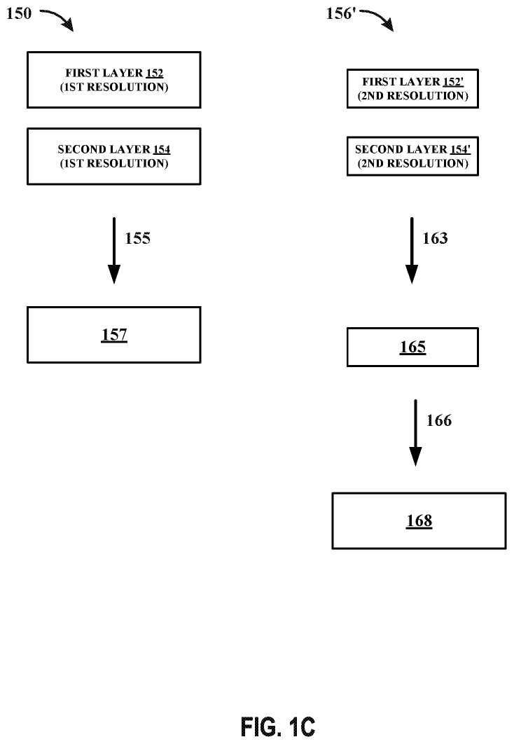

FIG. 1A is a block diagram that illustrates an example device 100 configured to perform one or more techniques of this disclosure. The device 100 includes display processing pipeline 102 configured to perform one or more technique of this disclosure. The display processing pipeline 102 may be communicatively coupled to a display 103. In the example of FIG. 1A, the display 103 is a display of the device 100. However, in other examples, the display 103 may be a display external to the device 100. In such examples, the device 100 may be configured to transmit or otherwise provide content to the display 103 for presentment thereon. In some examples, the display 103 of the device 100 may represent a display projector configured to project content, such as onto a viewing medium (e.g., a screen, a wall, or any other viewing medium). In some examples, the display 103 may include one or more of: a liquid crystal display (LCD), a plasma display, an organic light emitting diode (OLED) display, a projection display device, an augmented reality display device, a virtual reality display device, a head-mounted display, or any other type of display.

The device 100 may include or be connected to one or more input devices 113. In some examples, the one or more input devices 113 includes one or more of: a touch screen, a mouse, a peripheral device, an audio input device (e.g., a microphone or any other visual input device), a visual input device (e.g., a camera, an eye tracker, or any other visual input device), any user input device, or any input device configured to receive an input from a user. In some examples, the display 103 may be a touch screen display; and, in such examples, the display 103 constitutes an example input device 113.

The display processing pipeline 102 may include one or more components (or circuits) configured to perform one or more techniques of this disclosure. As used herein, reference to the display processing pipeline being configured to perform any function, technique, or the like refers to one or more components of the display processing pipeline being configured to form such function, technique, or the like.

In the example of FIG. 1A, the display processing pipeline 102 includes a first processing unit 104, a second processing unit 106, and a third processing unit 108. In some examples, the first processing unit 104 may be configured to execute one or more applications, the second processing unit 106 may be configured to perform graphics processing, and the third processing unit 108 may be configured to perform display processing. In such examples, the first processing unit 104 may be a central processing unit (CPU), the second processing unit 106 may be a graphics processing unit (GPU) or a general purpose GPU (GPGPU), and the third processing unit 108 may be a display processing unit (DPU), which may also be referred to as a display processor. In other examples, the first processing unit 104, the second processing unit 106, and the third processing unit 108 may each be any processing unit configured to perform one or more feature described with respect to each processing unit.

In some examples, the first processing unit 104 may be configured to perform any technique described herein with respect to the second processing unit 106. In such examples, the display processing pipeline 102 may only include the first processing unit 104 and the third processing unit 108. Alternatively, the display processing pipeline 102 may still include the second processing unit 106, but one or more of the techniques described herein with respect to the second processing unit 106 may instead be performed by the first processing unit 104.

In some examples, the first processing unit 104 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the first processing unit 104.

In some examples, the second processing unit 106 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the second processing unit 106.

The first processing unit 104 may be configured to perform one or more control processes 120 in accordance with the techniques described herein. In some examples, the one or more control processes 120 include any process/operation described herein with respect to the first processing unit 104. For example, the one or more control processes 120 may include one or more of: a triggering event monitoring operation, a triggering of sample collection operation, rendering tuning, correction feedback, rendering profile sharing, or any process described herein with respect to the first processing unit 104. The second processing unit 106 may be configured to perform graphics processing in accordance with the techniques described herein, such as in a graphics processing pipeline 111. Otherwise described, the second processing unit 106 may be configured to perform any process described herein with respect to the second processing unit 106. The third processing unit 108 may be configured to perform one or more display processing processes 122 in accordance with the techniques described herein. For example, the third processing unit 108 may be configured to perform one or more display processing techniques on one or more frames generated by the second processing unit 106 before presentment by the display 103. Otherwise described, the third processing unit 108 may be configured to perform display processing. In some examples, the one or more display processing processes 122 include one or more of a rotation operation, a blending operation, a scaling operating, any display processing process/operation, or any process/operation described herein with respect to the third processing unit 108. In some examples, the one or more display processing processes 122 include any process/operation described herein with respect to the third processing unit 108. The display 103 may be configured to display content that was generated using the display processing pipeline 102.

Content displayed on the display 103 may include one or more layers. The one or more layers may correspond to a single application or a plurality of applications executed by one or more components of the display processing pipeline 102 (e.g., by the first processing unit 104).

Content displayed on the display 103 may refer to display content. Display content may be a single frame, but may include one or more layers. As described herein, a layer may refer to a layer rendered by the second processing unit 106. A layer rendered by the second processing unit 106 may constitute a frame that is stored in a buffer accessible by the third processing unit 108. In examples where the content displayed on the display 103 include two or more layers, the single frame that is being displayed (i.e., the display content) includes two or more layers that have been blended or otherwise combined together into the single frame by the third processing unit 108.

For example, the second processing unit 106 may generate graphical content, which may include one or more layers. Each of these layers may constitute a frame of graphical content. The third processing unit 108 may be configured to perform composition on graphical content rendered by the second processing unit 106 to generate display content. For example, the third processing unit 108 may be configured to blend a plurality of layers (e.g., a plurality of frames generated by the second processing unit 106) together to generate a single frame for presentment on the display. This single frame may be referred to as display content. In some examples, display content includes N or more layers, where N is an integer greater than or equal to one.

In accordance with the techniques of this disclosure, one or more of the components of the display processing pipeline 102 is improved and the display processing pipeline 102 is improved. For example, the display processing pipeline 102 may be configured to control the resolution at which the second processing unit 106 generates graphical content. By controlling the resolution at which the second processing unit 106 generates content, the display processing pipeline 102 may be configured to control the power consumption of the second processing unit 106. For example, in accordance with the techniques described herein, to reduce the power consumption of the second processing unit 106, the first processing unit 104 may cause the second processing unit 106 to generate graphical content at resolution that is lower than the resolution at which the graphical content would normally be rendered. As another example, in accordance with the techniques described herein, to increase the power consumption of the second processing unit 106, the first processing unit 104 may cause the second processing unit 106 to generate graphical content at resolution that is higher than the resolution at which the graphical content would normally be rendered. As another example, in accordance with the techniques of this disclosure, the display processing pipeline 102 may be configured to change (e.g., with and/or without user input) the resolution at which the second processing unit generates graphical content. For example, the first processing unit 104 may be configured to generate rendering quality profiles for applications (e.g., frequently used applications) over time and apply a suitable rendering profile for an application on subsequent usage. A rendering profile may include information indicative of the resolution or resolutions at which the second processing unit 106 is to be instructed to generate graphical content. Generating graphical content at a first resolution that is lower than a second resolution reduces power consumption of the second processing unit 106. The techniques described herein may also reduce memory transactions during rendering by the second processing unit 106 and during display processing by the third processing unit 108.

In accordance with the techniques described herein, the display processing pipeline 102 may be configured to generate content destined for display and content that is not destined for display. The display processing pipeline 102 may be configured to use the content not destined for display to control the resolution at which the second processing unit 106 generates graphical content.

The display processing pipeline 102 may be configured to execute one or more applications. For example, the first processing unit 104 may be configured to execute one or more applications. The first processing unit 104 may be configured to cause the second processing unit 106 to generate content for the one or more applications being executed by the first processing unit 104. Otherwise described, execution of the one or more applications by the first processing unit 104 may cause the generation of graphical content by a graphics processing pipeline. For example, the first processing unit 104 may issue or otherwise provide instructions (e.g., draw instructions) to the second processing unit 106 that cause the second processing unit 106 to generate graphical content based on the instructions received from the first processing unit 104. The second processing unit 106 may be configured to generate one or more layers for each application of the one or more applications executed by the first processing unit 104. Each layer generated by the second processing unit 106 may be stored in a buffer. Otherwise described, the buffer may be configured to store one or more layers of graphical content rendered by the second processing unit 106. The buffer may reside in the internal memory 107 of the second processing unit 106 and/or the external memory 110 (which may be system memory of the device 100 in some examples). Each layer produced by the second processing unit 106 may constitute graphical content. The one or more layers may correspond to a single application or a plurality of applications. The second processing unit 106 may be configured to generate multiple layers of content, meaning that the first processing unit 104 may be configured to cause the second processing unit 106 to generate multiple layers of content.

In accordance with the techniques described herein, applications (or application views/layers corresponding to applications) can be calibrated for lower resolution rendering and/or lower frame but still have comparable quality. In some examples, such applications may include messaging applications, email applications, browser applications, Microsoft Office applications, Notepad, text-based application, and other applications.

In some examples, one or more components of the device 100 and/or display processing pipeline 102 may be combined into a single component. For example, one or more components of the display processing pipeline 102 may be one or more components of a system on chip (SoC), in which case the display processing pipeline 102 may still include the first processing unit 104, the second processing unit 106, and the third processing unit 108; but as components of the SoC instead of physically separate components. In other examples, one or more components of the display processing pipeline 102 may be physically separate components that are not integrated into a single component. For example, the first processing unit 104, the second processing unit 106, and the third processing unit 108 may each be a physically separate component from each other. It is appreciated that a display processing pipeline may have different configurations. As such, the techniques described herein may improve any display processing pipeline, not just the specific examples described herein.

In some examples, one or more components of the display processing pipeline 102 may be integrated into a motherboard of the device 100. In some examples, one or more components of the display processing pipeline 102 may be may be present on a graphics card of the device 100, such as a graphics card that is installed in a port in a motherboard of the device 100 or a graphics card incorporated within a peripheral device configured to interoperate with the device 100.

The first processing unit may include an internal memory 105. The second processing unit 106 may include an internal memory 107. The third processing unit 108 may include an internal memory 109. One or more of the processing units 104, 106, and 108 of the display processing pipeline 102 may be communicatively coupled to an external memory 110. The external memory 110 external to the one or more of the processing units 104, 106, and 108 of the display processing pipeline 102 may, in some examples, be a system memory. The system memory may be a system memory of the device 100 that is accessible by one or more components of the device 100. For example, the first processing unit 104 may be configured to read from and/or write to the external memory 110. The second processing unit 106 may be configured to read from and/or write to the external memory 110. The third processing unit 108 may be configured to read from and/or write to the external memory 110. The first processing unit 104, the second processing unit 106, and the third processing unit 108 may be communicatively coupled to the external memory 110 over a bus. In some examples, the one or more components of the display processing pipeline 102 may be communicatively coupled to each other over the bus or a different connection. In other examples, the system memory may be a memory external to the device 100.

The internal memory 105, the internal memory 107, the internal memory 109, and/or the external memory 110 may include one or more volatile or non-volatile memories or storage devices. In some examples, the internal memory 105, the internal memory 107, the internal memory 109, and/or the external memory 110 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 105, the internal memory 107, the internal memory 109, and/or the external memory 110 may be a non-transitory storage medium according to some examples. The term “non-transitory” may indicate that the storage medium is not embodied in a carrier wave or a propagated signal. However, the term “non-transitory” should not be interpreted to mean that the internal memory 105, the internal memory 107, the internal memory 109, and/or the external memory 110 is non-movable or that its contents are static. As one example, the external memory 110 may be removed from the device 100 and moved to another device. As another example, the external memory 110 may not be removable from the device 100.

The first processing unit 104, the second processing unit 106, and/or the third processing unit 108 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. In examples where the techniques described herein are implemented partially in software, the software (instructions, code, or the like) may be stored in a suitable, non-transitory computer-readable storage medium accessible by the processing unit. The processing unit may execute the software in hardware using one or more processors to perform the techniques of this disclosure. For example, one or more components of the display processing pipeline 102 may be configured to execute software. The software executable by the first processing unit 104 may be stored in the internal memory 105 and/or the external memory 110. The software executable by the second processing unit 106 may be stored in the internal memory 107 and/or the external memory 110. The software executable by the third processing unit 108 may be stored in the internal memory 109 and/or the external memory 110.

The device 100 may include a communication interface 112 configured to perform one or more technique of this disclosure, such as any transmission and/or receiving function described herein. For example, the device 100 may be configured to communicate with one or more devices. In the example of FIG. 1A, the device 100 may be configured to communicate with the device 130 and the device 140. In some examples, the device 130 may be a server and the device 140 may be a client device. In such examples, the device 130 and the device 140 may each be configured to perform one or more techniques of this disclosure. For example, as described herein, the display processing pipeline 102 (e.g., the first processing unit 104 of the display processing pipeline 102) may be configured to generate rendering profiles. A rendering profile may be shared among different devices. For example, rendering profiles may be shared among users possessing the same or similar devices to the device 100. In some examples, the exchange of rendering profiles may be facilitated via network providers across applications, individual application proprietors, and/or between the users via a wireless and/or wired connection. As one example, the device 130 may be a server and may function as an intermediary device and a hub for rendering profiles. In this example, the device 100 may be configured to communicate one or more rendering profiles to the device 130. The device 140 may similarly be configured to communicate one or more rendering profiles to the device 130. The device 100 may be configured to obtain one or more rendering profiles from the device 130. The device 140 may be configured to obtain one or more rendering profiles from the device 130. In some examples, the device 100 and the device 140 may be configured to share rendering profiles by communicating with each other. Communication between the device 100 and the device 140 may or may not include one or more intermediary network devices.

The communication interface 112 may include a receiver 114 and a transmitter 116. The receiver 114 may be configured to perform any receiving function described herein with respect to the device 100. For example, the receiver 114 may be configured to receive information (e.g., a rendering profile) from another device, such as a server. In some examples, in response to receiving information (e.g., a rendering profile), the display processing pipeline may be configured to perform one or more techniques described herein, such as produce or otherwise generate content based on the received rendering profile. The transmitter 116 may be configured to perform any transmitting function described herein with respect to the device 100. For example, the transmitter 116 may be configured to transmit information (e.g., a rendering profile). The device 100 may be configured to unicast, broadcast, multicast, or otherwise transmit information. The receiver 114 and the transmitter 116 may be combined into a transceiver 118. In such examples, the transceiver 118 may be configured to perform any receiving function and/or transmitting function described herein with respect to the device 100.

As described herein, a device, such as the device 100, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate content, or any device configured to perform one or more techniques described herein.

The device 100 may be configured to communicate with one or more other devices using the communication interface 112 to receive and/or transmit one or more rendering profiles. In some example, the communication coupling between the device 100 and the one or more devices with which the device 100 may communicate may comprise any type of medium or device capable of carrying information. In the example of FIG. 1A, the communication interface 112 may be configured to transmit information by being configured to modulate information according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the device 100 to one or more other devices. The communication medium may include routers, switches, base stations, or any other equipment that may be useful to facilitate communication to the device 100 from one or more other devices. In other examples, the communication interface 112 of the device 100 may enable a point-to-point connection between the device 100 and one or more other devices. The point-to-point connection may be a wired and/or wireless connection.

As described herein, devices, components, or the like may be described herein as being configured to communicate with each other. For example, one or more components of the display processing pipeline 102 may be configured to communicate with one or more other components of the device 100, such as the display 103, the external memory 110, and/or the communication interface 112. One or more components of the display processing pipeline 102 may be configured to communicate with each other. For example, the first processing unit 104 may be communicatively coupled to the second processing unit 106 and/or the third processing unit 108. As another example, the second processing unit 106 may be communicatively coupled to the first processing unit 104 and/or the third processing unit 108. As another example, the third processing unit 108 may be communicatively coupled to the first processing unit 104 and/or the second processing unit 106.

Communication may include the communicating of information from a first component to a second component (or from a first device to a second device). The information may, in some examples, be carried in one or more messages. As an example, a first component in communication with a second component may be described as being communicatively coupled to or otherwise with the second component. For example, the first processing unit 104 and the second processing unit 106 may be communicatively coupled. In such an example, the first processing unit 104 may communicate information to the second processing unit 106 and/or receive information from the second processing unit 106. As another example, a device and a server may be communicatively coupled. As another example, a server may be communicatively coupled to a plurality of client devices. As another example, any device described herein configured to perform one or more techniques of this disclosure may be communicatively coupled to one or more other devices configured to perform one or more techniques of this disclosure. As another example, any component described herein configured to perform one or more techniques of this disclosure may be communicatively coupled to one or more other components configured to perform one or more techniques of this disclosure. In some examples, when communicatively coupled, two devices may be actively communicating (e.g., transmitting or receiving) information, or may be configured to communicate (e.g., transmit or receive) information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices is inclusive of more than two devices. For example, a first device may communicatively couple with a second device and the first device may communicatively couple with a third device. In such an example, the first device may be a server.

In some examples, the term “communicatively coupled” may refer to a communication connection, which may be direct or indirect. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the device 100, may be configured to unicast, broadcast, multicast, or otherwise transmit information to one or more other devices. In some examples, a communication connection may enable the communication of information (e.g., the output of information, the transmission of information, the reception of information, or the like). For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described herein, such as the device 100, may be configured to operate in accordance with one or more communication protocols. For example, the device 100 may be configured to communicate with (e.g., receive information from and/or transmit information to) one or more other devices using one or more communication protocols. In such an example, the device 100 may be described as communicating with the one or more other devices over a connection. The connection may be compliant or otherwise be in accordance with a communication protocol.

As used herein, the term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, or 5G.

With reference to FIG. 1A, the first processing unit 104 may be configured to perform one or more control processes 120. As one example, the first processing unit 104 may be configured to monitor the layout of application views (e.g., widgets) and the geometry of the layers that are used (e.g., layers that are frequently used and have a high probability of recurrence in future). An application view may include one or more layers rendered by the GPU that are blended together using the third processing unit 108 to generate a frame for presentment on a display.

As another example, the first processing unit 104 may be configured to trigger sample collection upon the occurrence of a trigger event. The trigger event may be a user-initiated event (e.g., the trigger event may be a user input), a device-initiated event (e.g., an event initiated without user input), an event indicative of an idle state, such as an idle state of the first processing unit 104, an idle state of the second processing unit 106, or an idle state of the device 100. For example, the trigger event may include when the device 100 goes into idle state. An idle state of the device 100 may include when the device 100 has a static screen for one or more select applications, when no user input is detected, when no system-generated input is detected (e.g., an input generated by an application), or any other event indicative of an idle state. Collecting samples during an idle state may be preferred so that sample collection does not interfere with operations that are performed when not in idle state. For example, collecting samples during an idle state of the device 100 may be preferred so that sample collection does not interfere with operations that are performed by the device 100 when the device 100 is not in idle state.

During sample collection, the second processing unit 106 may be configured to generate graphical content (e.g., one or more layers) not for display, and the third processing unit 108 may be configured to generate one or more frames using the graphical content that was generated not for display. In some examples, to generate the one or more frames, the third processing unit 108 may be configured to scale (e.g., upscale or downscale) the graphical content that was generated not for display. Otherwise described, the generated graphical content not for display may be used by the third processing unit 108 to generate one or more frames not for display.

The third processing unit 108 may be configured to obtain the generated graphical content not for display, such as from the second processing unit 106 or a memory accessible to both the second and third processing units 106 and 108 (e.g., the external memory 110). The one or more frames not for display may be compared to a previously displayed frame to determine a quality difference between them. For example, the first processing unit 104 may be configured to obtain the one or more frames not for display, such as from the third processing unit 108 or a memory accessible to both the first and third processing units 104 and 108 (e.g., the external memory 110). Upon obtaining the one or more frames that were generated by the third processing unit 108 not for display, the first processing unit 104 may be configured to compare these one or more frames to a previously displayed frame to determine a quality difference between them. In some examples, determination of a quality difference may refer to determination of an image quality metric. For example, determination of an image quality metric may be determined based on the comparison of two frames: a first frame and a second frame, where the first frame is a frame generated for display and the second frame is a frame generated not for display. In some examples, the image quality metric is a peak signal to noise ratio (PSNR) value or a structural similarity (SSIM) index value.

In some examples, the first processing unit 104 may be configured to generate a rendering profile based on the comparison of two frames. For example, the first processing unit 104 may be configured to generate a rendering profile based on an image quality metric. In some examples, the first processing unit 104 may be configured to cause the second processing unit 106 to generate graphical content based on the generated rendering profile. The first processing unit 104 may be configured to control how the second processing unit 106 generates graphical content. For example, the first processing unit 104 may be configured to control the resolution at which the second processing unit 106 without user input or based on user input. In some examples, a user may opt for the first processing unit 104 to perform automatic resolution adjustment or opt for a resolution recommendation notification/prompt. A prompt may include a message displayed on the display 103 giving the user an option to select whether the user prefers that the first processing unit 104 automatically perform resolution adjustment or if the user prefers to receive a resolution adjustment notification. In the latter example, the user may be presented with a resolution adjustment recommendation to which the user could either accept or deny. In terms of presentment of a message, notification, recommendation, prompt or the like, the display processing pipeline 102 may be configured generate such graphical content for display.

The first processing unit 104 may be configured to analyze the image quality metrics associated with different resolutions for different application views. The first processing unit 104 may be configured to identify a minimum common resolution at which the second processing unit 106 may be configured to generate graphical content at that yields uniform quality, which may result in reducing or preventing an abrupt change in the quality of content presented on the display 103. Following one or more comparison tests, the first processing unit 104 may be configured to cause the second processing unit 106 to generate graphical content at a different resolution. A comparison test may also be referred to a resolution test, which is where the first processing unit 104 compares two frames to determine an image quality metric.

Regarding the image quality metric, this metric may be information that is indicative of the differences (e.g., visible differences) between two images (e.g., two frames). In some examples, the information may indicate that the differences between the two images are high. In other examples, the information may indicate that the differences between the two images are low. The first processing unit 104 may be configured to compare a determined image quality metric to a threshold image quality metric. In some examples, a high image quality metric may be indicative that the differences between two compared images are high and a low image quality metric may be indicative that the differences between two compared images are low. In such examples, the first processing unit 104 may be configured to refrain from adjusting the resolution at which the second processing unit 106 generates graphical content when the determined image quality metric is above the threshold, and may be configured to adjust the resolution at which the second processing unit 106 generates graphical content when the determined image quality metric is below the threshold. In other examples, a high image quality metric may be indicative that the differences between two compared images are low and a low image quality metric may be indicative that the differences between two compared images are high. In such examples, the first processing unit 104 may be configured to refrain from adjusting the resolution at which the second processing unit 106 generates graphical content when the determined image quality metric is below the threshold, and may be configured to adjust the resolution at which the second processing unit 106 generates graphical content when the determined image quality metric is above the threshold.

As used herein, a frame generated for display by the third processing unit 108 may refer to a frame generated for display (i.e., a display frame) and/or a frame previously displayed. Similarly, as used herein, a frame generated not for display by the third processing unit 108 may refer to a frame generated only for comparison to a frame generated for display, the former frame being referred to as a non-display frame, a sample collection frame, a comparison frame, a quality check frame, an image quality metric check frame, or the like. A frame may include one or more layers. In some examples, a layer may refer to a frame generated by the second processing unit 106 and a frame generated by the third processing unit 108 may be referred to as a display frame or a non-display frame.

Before occurrence of a trigger event, the display processing pipeline 102 may be configured to generate graphical content (e.g., one or more layers) at a first resolution. For example, before occurrence of a trigger event, the second processing unit 106 may be configured to generate graphical content at a first resolution. Graphical content generated at the first resolution may be blended together by the third processing unit 108 to generate a first frame for display. In other examples, graphical content generated at the first resolution may not be blended with other graphical content to generate the first frame for display. As used herein with respect to the second processing unit 106, the terms “generate” and “render” may be interchangeable.

Upon occurrence of a trigger event, the display processing pipeline 102 may be configured to generate graphical content (e.g., one or more layers) at a second resolution. In some examples, the second resolution may be lower than the first resolution. In other examples, the second resolution may be higher than the first resolution. Graphical content generated at the second resolution may be blended together by the third processing unit 108 to generate a second frame not for display. In other examples, graphical content generated at the second resolution may not be blended with other graphical content to generate the second frame not for display. The third processing unit 108 may be configured to scale (e.g., upscale or downscale) the second frame to the first resolution. For example, the third processing unit 108 may be configured to upscale the second frame to the first resolution in the example where the second resolution is lower than the first resolution. As another example, the third processing unit 108 may be configured to downscale the second frame to the first resolution in the example where the second resolution is higher than the first resolution. The scaled second frame may be referred to as a test frame or a resolution test frame. This resolution test frame is not output for presentment on a display. Instead, the first processing unit 104 obtains the resolution test frame, and the first processing unit 104 compares the resolution test frame and the first frame to determine an image quality metric.

As referenced herein, the first processing unit 104 may be configured to compare two frames: a first frame and a second frame. In some examples, the first frame may be a display frame and the second frame may be a non-display frame. In other examples, the first frame may be a non-display frame and the second frame may be a non-display frame. The first frame and the second frame may include the same graphical content to enable the first processing unit 104 to determine a more accurate image quality metric compared to if the first and second frames did not include the same graphical content.

For example, the first frame may include first graphical content that includes a first layer and a second layer generated by the second processing unit 106 at a first resolution. In this example, the second frame may include the first graphical content, but the first layer and/or the second layer have been scaled by the third processing unit 108 to generate the second frame. Otherwise described, the first layer and/or the second layer are scaled layers and are at the first resolution. However, unlike the first frame in which the second processing unit 106 generated the first and second layers at the first resolution, the scaled layer(s) in the second frame (i.e., the first layer and/or second layer) were not generated at the first resolution. Instead, the second processing unit 106 generated the first layer and/or the second layer for the second frame at a second resolution. Subsequently, the third processing unit 108 generated the second frame by scaling the second resolution layer(s) or the second frame to the first resolution. In some examples, the third processing unit 108 may be configured to scale graphical content and then blend scaled graphical content together to generate a frame. In other examples, the third processing unit 108 may be configured to blend graphical content together and then scale the blended graphical content together to generate a frame. In other examples, the third processing unit 108 may be configured to scale before blending and scale after blending.

As another example, a first set of frames may be rendered a first time (e.g., not during sample collection) at first resolution (e.g., 1080p) and blended together resulting in a display frame. In this example, the first set of frames may be rendered a second time (e.g., during sample collection), but this time at a second resolution (e.g., 720p) different from the first resolution. The first set of frames rendered at the second resolution may then be blended together resulting in a non-scaled, blended frame at the second resolution. The non-scaled, blended frame may then be scaled to the first resolution resulting in a non-display frame. The display frame and the non-display frame may be compared to determine an image quality metric. A rendering profile may be generated based on the image quality metric. For example, the rendering profile may be generated when the image quality metric is above, below, or equal to a threshold value.

FIG. 1B illustrates an example of scaling before blending in accordance with the techniques described herein. In the example of FIG. 1B, graphical content 150 includes a first layer 152 and a second layer 154. Each layer in the example of FIG. 1B may also be referred to as a frame. The graphical content in this example was generated by the second processing unit 106 at a first resolution. The third processing unit 108 may be configured to blend the first layer 152 and the second layer 154 together (shown by arrow 155) to generate the frame 157. FIG. 1B also illustrates an example of graphical content 156 that includes a first layer 152′ and the second layer 154. In this example, the first layer 152′ was generated by the second processing unit 106 at a second resolution and the second layer 154 was generated by the second processing unit 106 at the first resolution. In some examples, the second layer 154 may be generated by the second processing unit 106 for the generation of the frame 157, and may be re-used for the generation of the frame 164. In such examples, the second layer 154 may be generated once but obtained from a memory (e.g., the internal memory 107 and/or the external memory 110) for use in generating one or more subsequent frames for which the second layer 154 was originally generated. In other examples, the second layer 154 may be generated each time. The first layer 152 and the first layer 152′ include the same graphical content, meaning the graphical content in the first layer 152 and the first layer 152 is the same with the exception of the difference in resolution. For example, if the graphical content includes an object, the object would be in both the first layer 152 and the first layer 152′. However, the object in the first layer 152 would have more pixels compared to the object in the first layer 152′ because the first layer 152 was rendered at the first resolution, shown as being higher than the second resolution in this example. The object in the first layer 152′ would have less pixels compared to the object in the first layer 152 because the first layer 152′ was rendered at the second resolution, shown as being lower than the first resolution in this example. The second layer 154 is shown as being the same for the graphical content 150 and the graphical content 156.

The third processing unit 108 may be configured to scale (e.g., upscale or downscale) the first layer 152′ to the first resolution to generate a scaled first layer 152″. In the example of FIG. 1B, the second resolution is lower than the first resolution; and, as such, the scaling operation shown by arrow 159 is an upscaling operation performed by the third processing unit 108. The third processing unit 108 may be configured to blend the scaled first layer 152″ and the second layer 154 together (shown by arrow 162) to generate the frame 164. In some examples, the first resolution may be the display resolution, meaning the resolution at which the content is displayed. In other examples, the first resolution may be different from the display resolution (e.g., less than or greater than the display resolution).

The first processing unit 104 may be configured to compare the frame 157 and the frame 164 to determine an image quality metric. Based on the image quality metric, the first processing unit 104 may be configured to generate a rendering profile indicative that the quality of the frame 164 relative to the frame 157 is acceptable. For example, the rendering profile may include information indicative that the first layer for the application for which this graphical content was rendered is to be rendered at the second resolution. Outside of the sample collection process, the first processing unit 104 may be configured to provide one or more instructions to the second processing unit 106 based on the rendering profile. For example, the one or more instructions may cause the second processing unit 106 to generate graphical content (e.g., graphical content for the first layer in this example) for the application at the second resolution when the rendering profile includes information indicative that the second resolution is to be used for generating graphical content for display.

In some examples, the frame 157 may be a display frame and the frame 164 may be a non-display frame. In other examples, the frame 157 may be a non-display frame and the frame 164 may be a non-display frame.

FIG. 1C illustrates an example of scaling after blending in accordance with the techniques described herein. In the example of FIG. 1C, graphical content 150 includes a first layer 152 and a second layer 154. Each layer in the example of FIG. 1C may also be referred to as a frame. The graphical content in this example was generated by the second processing unit 106 at a first resolution. In some examples, the first resolution may be the display resolution, meaning the resolution at which the content is displayed. In other examples, the first resolution may be different from the display resolution (e.g., less than or greater than the display resolution). The third processing unit 108 may be configured to blend the first layer 152 and the second layer 154 together (shown by arrow 155) to generate the frame 157. FIG. 1C also illustrates an example of graphical content 156′ that includes a first layer 152′ and a second layer 154′. In this example, the first layer 152′ was generated by the second processing unit 106 at a second resolution and the second layer 154′ was generated by the second processing unit 106 at the second resolution. The first layer 152 and the first layer 152′ include the same graphical content, meaning the graphical content in the first layer 152 and the first layer 152 is the same with the exception of the difference in resolution. For example, if the graphical content includes a first object, the first object would be in both the first layer 152 and the first layer 152′. However, the first object in the first layer 152 would have more pixels compared to the first object in the first layer 152′ because the first layer 152 was rendered at the first resolution, shown as being higher than the second resolution in this example. The first object in the first layer 152′ would have less pixels compared to the first object in the first layer 152 because the first layer 152′ was rendered at the second resolution, shown as being lower than the first resolution in this example. The second layer 154 and the second layer 154′ include the same graphical content, meaning the graphical content in the second layer 154 and the second layer 154 is the same with the exception of the difference in resolution. For example, if the graphical content includes a second object, the second object would be in both the second layer 154 and the second layer 154′. However, the second object in the second layer 154 would have more pixels compared to the second object in the second layer 154′ because the second layer 154 was rendered at the first resolution, shown as being higher than the second resolution in this example. The second object in the second layer 154′ would have less pixels compared to the second object in the second layer 154 because the second layer 154′ was rendered at the second resolution, shown as being lower than the first resolution in this example.

The third processing unit 108 may be configured to blend the first layer 152′ and the second layer 154′ together (shown by arrow 163) to generate the frame 165 (which may be referred to as a blended frame). The third processing unit 108 may be configured to scale (e.g., upscale or downscale) the frame 165 to the first resolution to generate a scaled frame 168 at the first resolution. In the example of FIG. 1C, the second resolution is lower than the first resolution; and, as such, the scaling operation shown by arrow 166 is an upscaling operation performed by the third processing unit 108.

The first processing unit 104 may be configured to compare the frame 157 and the frame 168 to determine an image quality metric. Based on the image quality metric, the first processing unit 104 may be configured to generate a rendering profile indicative that the quality of the frame 168 relative to the frame 157 is acceptable. For example, the rendering profile may include information indicative that the first and second layers for the application for which this graphical content was rendered is to be rendered at the second resolution. Outside of the sample collection process, the first processing unit 104 may be configured to provide one or more instructions to the second processing unit 106 based on the rendering profile. For example, the one or more instructions may cause the second processing unit 106 to generate graphical content (e.g., graphical content for the first layer and the second layer in this example) for the application at the second resolution when the rendering profile includes information indicative that the second resolution is to be used for generating graphical content for display.

In some examples, the frame 157 may be a display frame and the frame 168 may be a non-display frame. In other examples, the frame 157 may be a non-display frame and the frame 168 may be a non-display frame.

FIGS. 1B and 1C are examples of blending and scaling. However, in accordance with the techniques described herein, the third processing unit 108 may be configured to blend and/or scale any graphical content, whether the graphical content was generated for display or was not generated for display. In some examples, graphical content may be blended and then scaled. In other examples, graphical content may be scaled and then blended. In other examples, graphical content may be scaled, then blended, and then blended content may be scaled. The number and order of blending and/scaling operations may be application specific. Therefore, the techniques of this disclosure include any number and any order of blending and/scaling operations.

As used herein, resolution may refer to the number of pixels in an image, frame, layer, or the like. Resolution may be identified by a width and a height, such as X×Y pixels, where X is and Y are both positive numbers. For example, a first resolution may include X1×Y1 pixels and a second resolution may include X2×Y2 pixels. In some examples, the first resolution may be lower than the second resolution, which may be described as (X1×Y1)<(X2×Y2). In other examples, the first resolution may be higher than the second resolution, which may be described as (X1×Y1)>(X2×Y2). For example, the resolution of 1920×1080 (which may be referred to as 1080p) is higher than the resolution of 1280×720 (which may be referred to as 720p). Depending on the example, both X1 and Y1 may have values different from X2 and Y2, respectively (meaning that both the height and the width are different between the two resolutions). However, in other examples, a difference in resolution may mean that only the height or the width is different between two resolutions.

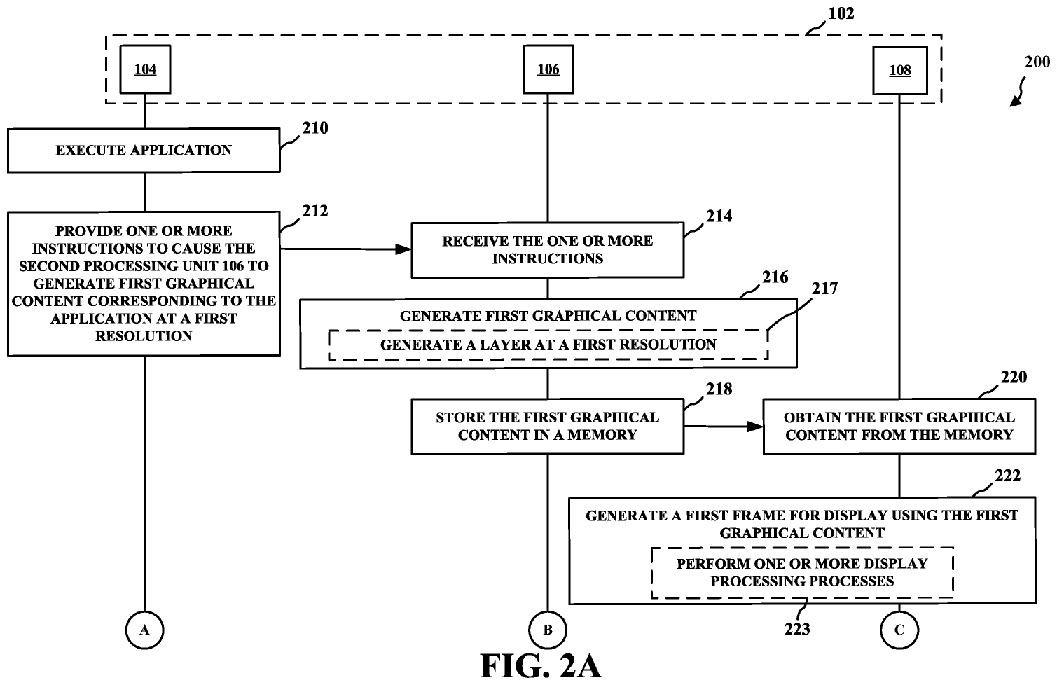

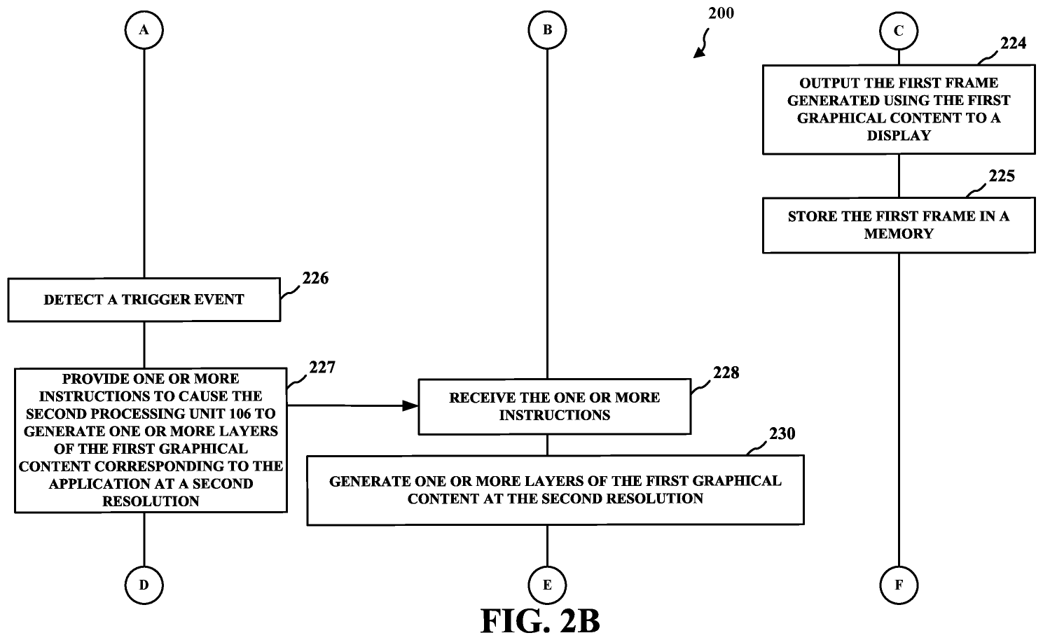

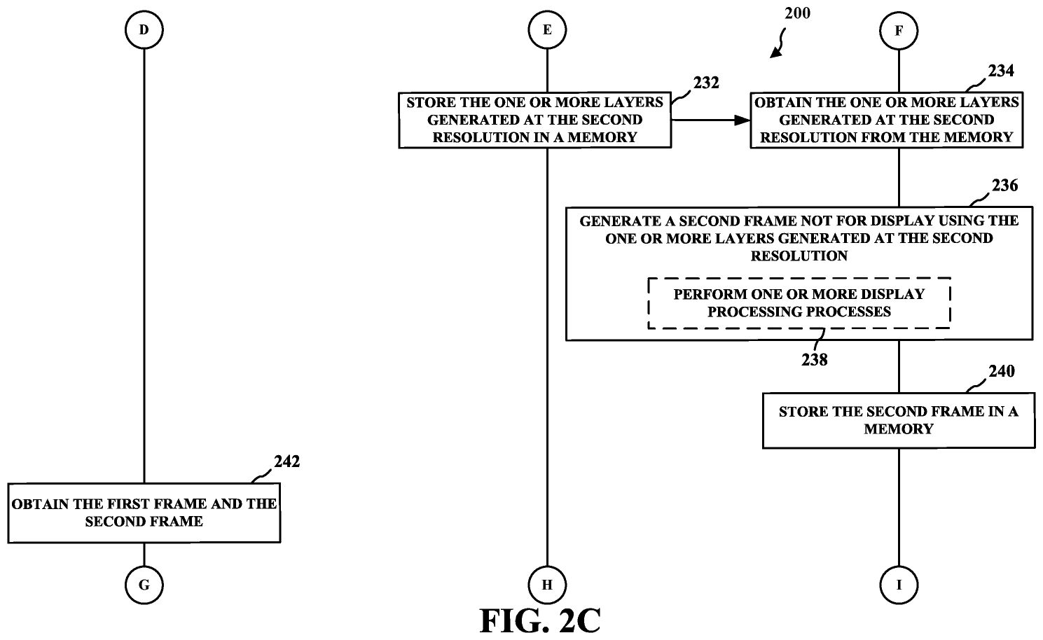

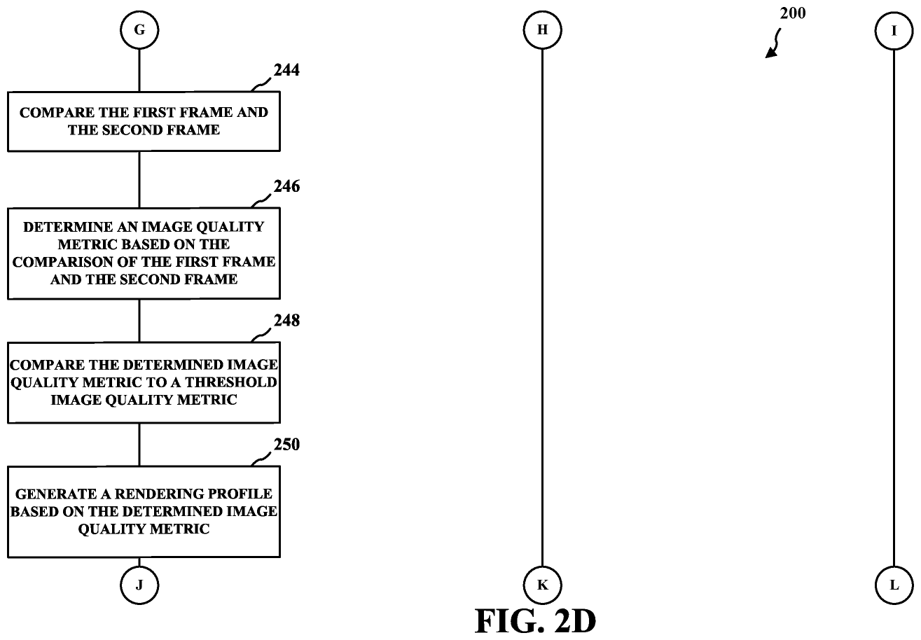

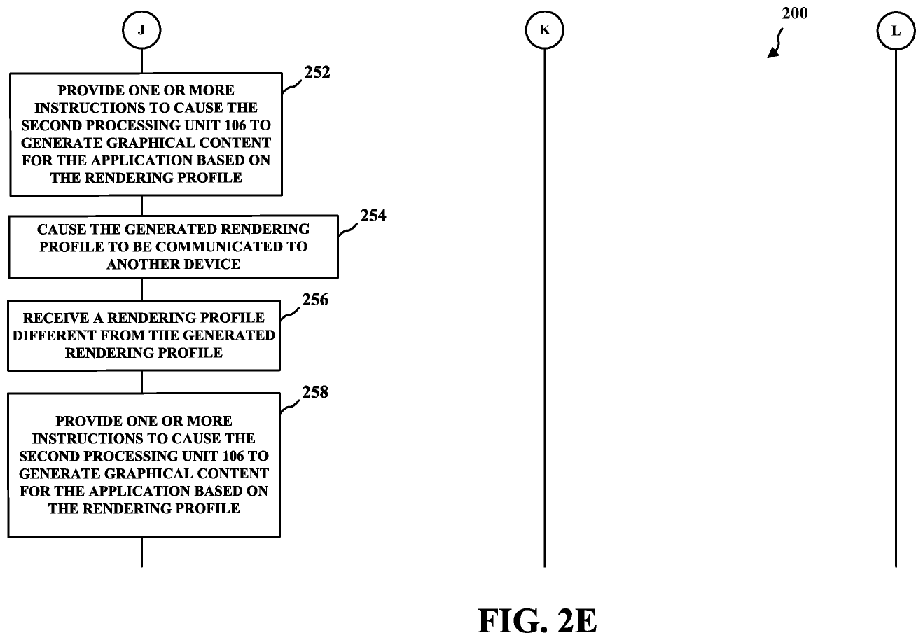

FIGS. 2A-2E illustrate an example flow diagram 200 in accordance with the techniques described herein. In other examples, one or more techniques described herein may be added to the flow diagram 200 and/or one or more techniques depicted in the flow diagram may be removed.

In the example of FIGS. 2A-E, at block 210, the first processing unit 104 may be configured to execute an application. At block 212, the first processing unit 104 may be configured to provide one or more instructions to the second processing unit 106 to cause the second processing unit 106 to generate first graphical content corresponding to the application at a first resolution. The first graphical content may include one or more layers.

At block 214, the second processing unit 106 may be configured to receive the one or more instructions. At block 216, the second processing unit 106 may be configured to generate the first graphical content at the first resolution based on the one or more instructions received from the first processing unit 104. Block 217 represents an example in which generation of the first graphical content at the first resolution includes generation of a first layer at a first resolution. At block 218, the second processing unit 106 may be configured store the generated first graphical content in a memory (e.g., the internal memory 107 and/or the external memory 110).

At block 220, the third processing unit 208 may be configured to obtain the generated first graphical content from a memory (e.g., the internal memory 107 and/or the external memory 110). At block 222, the third processing unit 208 may be configured to generate a first frame for display using the generated first graphical content. To generate the first frame for display, the third processing unit 108 may be configured to perform one or more display processing processes 223 on the generated first graphical content. At block 224, the third processing unit 108 may be configured to output the first frame generated using the first graphical content to a display (e.g., display 103). At block 225, the third processing unit 108 may be configured to store the first frame in a memory (e.g., the internal memory 109 and/or the external memory 110).

At block 226, the first processing unit 104 may detect a trigger event. The first processing unit 104 may be monitoring for the trigger event, such as via an interrupt service routine or the like. The trigger event may be a user-initiated event (e.g., the trigger event may be a user input), a device-initiated event (e.g., an event initiated without user input), an event indicative of an idle state, such as an idle state of the first processing unit 104, an idle state of the second processing unit 106, or an idle state of the device 100. For example, the trigger event may include when the device 100 goes into idle state. An idle state of the device 100 may include when the device 100 has a static screen for one or more select applications, when no user input is detected, when no system-generated input is detected (e.g., an input generated by an application), or any other event indicative of an idle state.

In response to detection of the trigger event, the first processing unit 104 may be configured to trigger sample collection. As used herein, sample collection may refer to a process in which the display processing pipeline 102 is configured to generate one or more non-display frames for comparison with the first frame and/or one or more non-display frames. For example, the first processing unit 104 may be configured to cause the one or more display frames to be generated. The second processing unit 106 may be configured to generate graphical content having one or more layers at different resolutions for the one or more non-display frames. To generate the one or more non-display frames, the third processing unit 108 may be configured to perform one or more display processing processes on the graphical content generated for the one or more non-display frames.

Block 227 is an example of the display processing pipeline initiating sample collection (which may, in some examples be referred to as a process in which content previously generated at a first resolution by the second processing unit 106 is re-generated by the second processing unit 106 at a resolution different from the first resolution). In the example of FIGS. 2A-2C, at block 227, the first processing unit 104 may be configured to provide one or more instructions to cause the second processing unit 106 to generate one or more layers of the first graphical content corresponding to the application at a second resolution.

At block 228, the second processing unit 106 may be configured to receive the one or more instructions initiating sample collection. At block 230, the second processing unit 106 may be configured to generate one or more layers of the first graphical content at the second resolution based on the one or more instructions received from the first processing unit 104. At block 232, the second processing unit 106 may be configured store the one or more layers generated at the second resolution in a memory (e.g., the internal memory 107 and/or the external memory 110).

At block 234, the third processing unit 208 may be configured to obtain the one or more layers generated at the second resolution from a memory (e.g., the internal memory 107 and/or the external memory 110). At block 236, the third processing unit 208 may be configured to generate a second frame not for display using the one or more layers generated at the second resolution. In some examples, the second frame may include one or more layers generated at the first resolution. In such examples, the third processing unit 108 may be configured to receive these one or more layers that were generated by the second processing unit 106 before initiation of the sample collection from the memory location in which they were stored for generation of the first frame. As an example, with reference to FIG. 1B, the first frame may correspond to frame 157 and the second frame may correspond to frame 164. In the example of FIG. 1B, the first layer is generated twice, a first time outside of the sample collection process (e.g., before the sample collection process is initiated) at the first resolution, and a second time during the sample collection process at the second resolution. Conversely, the second layer may be generated once and re-used, or the second layer may be generated twice.

To generate the second frame not for display, the third processing unit 108 may be configured to perform one or more display processing processes 238 on the generated first graphical content. The one or more display processing processes 223 differs from the one or more display processing processes 238 because the one or more display processing processes 238 includes at least one scaling operation that the one or more display processing processes 223 does not include. At block 240, the third processing unit 108 may be configured to store the second frame in a memory (e.g., the internal memory 109 and/or the external memory 110).

At block 242, the first processing unit 104 may be configured to obtain the first frame and the second frame, such as from the internal memory 109 and/or the external memory 110. At block 244, the first processing unit 104 may be configured to compare the first and second frames. At block 246, the first processing unit 104 may be configured to determine an image quality metric based on the comparison of the first frame and the second frame. In some examples, the comparison of two frames includes an image quality algorithm that receives two frames as an input and outputs an image quality metric value. In such examples, the determination of an the image quality metric based on the comparison of the two frames may constitute the generation of the image quality check value based on the comparison of the two frames. Otherwise described, determination of an image quality metric may, in some examples, be synonymous with generation of an image quality metric.

At block 248, the first processing unit 104 may be configured to compare the determined image quality metric to a threshold image quality metric. In some examples, a high image quality metric may be indicative that the differences between two compared images are high and a low image quality metric may be indicative that the differences between two compared images are low. In such examples, the first processing unit 104 may be configured to refrain from adjusting the resolution at which the second processing unit 106 generates graphical content when the determined image quality metric is above the threshold, and may be configured to adjust the resolution at which the second processing unit 106 generates graphical content when the determined image quality metric is below the threshold. In other examples, a high image quality metric may be indicative that the differences between two compared images are low and a low image quality metric may be indicative that the differences between two compared images are high. In such examples, the first processing unit 104 may be configured to refrain from adjusting the resolution at which the second processing unit 106 generates graphical content when the determined image quality metric is below the threshold, and may be configured to adjust the resolution at which the second processing unit 106 generates graphical content when the determined image quality metric is above the threshold.

For example, if at block 248 the comparison of the determined image quality metric to the threshold image quality metric is indicative that the differences between the first and second frames are acceptable (e.g., the differences are low), the first processing unit may be configured to generate a rendering profile based on the image quality metric at block 250. However, if at block 248 the comparison of the determined image quality metric to the threshold image quality metric is indicative that the differences between the first and second frames are unacceptable (e.g., the differences are high), the first processing unit may be configured to refrain from generating a rendering profile.

Referring to block 250, a rendering profile may include information indicative of the resolution or resolutions at which the second processing unit 106 is to be instructed to generate graphical content (e.g., one or more layers) for the application (i.e., the application for which the first frame and the second frame were generated). In some examples, a rendering profile is a data structure that identifies the respective resolution for each respective layer in an application view for an application at which the second processing unit 106 is to be instructed to generate the graphical content. As an example, with reference to FIG. 1B, a rendering profile may be generated after the comparison of frames 164 and 157, which indicates that the first layer in the application view is to be generated at the second resolution and the second layer in the application view is to be generated at the first resolution. As another example, with reference to FIG. 1C, a rendering profile may be generated after the comparison of frames 168 and 157, which indicates that the first layer in the application view is to be generated at the second resolution and the second layer in the application view is to be generated at the second resolution. Both of these examples with respect to FIGS. 1B and 1C assume that the first processing unit 104 has determined that the differences between the compared frames are acceptable.

If at block 248 the comparison of the determined image quality metric to the threshold image quality metric is indicative that the differences between the first and second frames are acceptable (e.g., the differences are low), the rendering profile may be generated to include information indicative that the second resolution is to be the resolution at which the second processing unit 106 generates select graphical content for display (i.e., the one or more layers that were generated at the second resolution instead of the first resolution during the sample collection).

At block 252, the first processing unit 104 may be configured to provide one or more instructions to cause the second processing unit 106 to generate graphical content for the application based on the rendering profile. Otherwise described, the first processing unit 104 may be configured to analyze the generated rendering profile to determine which resolution(s) the second processing unit 106 is to use for generating graphical content. In the example of FIGS. 2A-2E, the one or more instructions provided at block 252 may cause the second processing unit 106 to generate graphical content for the application at the second resolution when the rendering profile includes information indicative that the second resolution is to be used for generating graphical content for display. In this example, the rendering profile includes information indicative that the differences between the first and second frames that were compared are acceptable; and, as such, subsequent generation of graphical content for the application may be generated at the second resolution instead of the first resolution. As another example, the one or more instructions provided at block 252 may cause the second processing unit 106 to generate graphical content for the application at the first resolution when the rendering profile includes information indicative that the first resolution is to be used for generating graphical content for display. In this example, the rendering profile includes information indicative that the differences between the first and second frames that were compared are unacceptable; and, as such, subsequent generation of graphical content for the application may be generated at the first resolution.

In some examples, the first processing unit 104 may cause the generated rendering profile to be communicated to another device (e.g., device 130 and/or device 140), such as at block 254. In some examples, the first processing unit 104 may receive a rendering profile (e.g., from device 130 and/or device 140) different from the generated rendering profile, such as at block 256. In such examples, the first processing unit 104 may be configured to provide one or more instructions to cause the second processing unit 106 to generate graphical content for the application based on the received rendering profile, as shown at block 258.

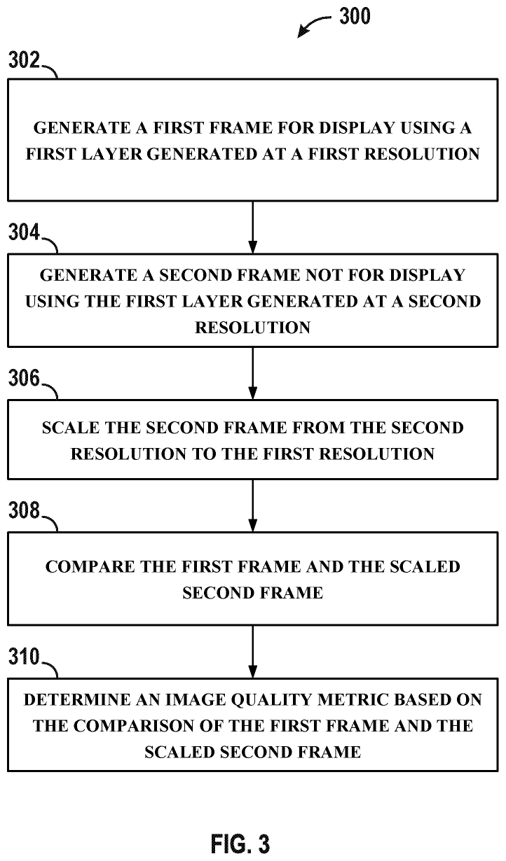

FIG. 3 illustrates an example flowchart 300 of a method of content adaptive rendering in accordance with one or more techniques of this disclosure. The method may be performed by one or more components of a first apparatus. The first apparatus may, in some examples, be the device 100. In some examples, the method illustrated in flowchart 300 may include one or more functions described herein that are not illustrated in FIG. 3, and/or may exclude one or more illustrated functions.

At block 302, a display processing unit of the first apparatus may be configured to generate a first frame for display using a first layer generated at a first resolution. In some examples, the first layer is associated with a first application. At block 304, the display processing unit may be configured to a second frame not for display using the first layer generated at a second resolution. In some examples, the first resolution is different from the second resolution. At block 306, the display processing unit may be configured to scale the second frame from the second resolution to the first resolution. At block 308, a first processing unit of the apparatus may be configured to compare the first frame and the scaled second frame. At block 310, the first processing unit may be configured to determine an image quality metric based on the comparison of the first frame and the scaled second frame.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

1. A method comprising:
generating, by a display processing unit, a first frame for display using a first layer generated at a first resolution, wherein the first layer is associated with a first application;
generating, by the display processing unit, a second frame not for display using the first layer generated at a second resolution, wherein the first resolution is different from the second resolution;
scaling, by the display processing unit, the second frame from the second resolution to the first resolution;
comparing, by a first processing unit, the first frame and the scaled second frame; and
determining, by the first processing unit, an image quality metric based on the comparison of the first frame and the scaled second frame.

2. The method of claim 1, wherein scaling comprising upscaling.

3. The method of claim 1, wherein scaling comprising downscaling.

4. The method of claim 1, wherein the image quality metric is a peak signal to noise ratio (PSNR) value or a structural similarity (SSIM) value.

5. The method of claim 1, further comprising:
generating, by a graphics processing unit (GPU), the first layer at the first resolution.

6. The method of claim 5, further comprising:
detecting, by the first processing unit, a trigger event; and
causing, by the first processing unit, the GPU to generate the first layer at the second resolution in response to the trigger event.

7. The method of claim 6, wherein the second resolution is less than the first resolution.

8. The method of claim 6, wherein the second resolution is greater than the first resolution.

9. The method of claim 6, wherein the first processing unit is a central processing unit (CPU).

10. The method of claim 6, wherein the trigger event comprises an idle event.

11. The method of claim 10, wherein the idle event comprises an idle event of a component of a device, wherein the component of the device includes the GPU, the display processing unit, or the first processing unit.

12. The method of claim 11, wherein the idle event comprises the component of the device entering an idle state.

13. The method of claim 10, wherein a device includes the GPU, and wherein the idle event comprises the device entering an idle state.

14. The method of claim 1, further comprising:
generating, by the first processing unit, a rendering profile based on the image quality metric.

15. The method of claim 14, further comprising:
causing, by the first processing unit, the GPU to generate a second layer at a third resolution based on the rendering profile, wherein the second layer is associated with the first application.

16. The method of claim 15, wherein the third resolution is the same as the second resolution.

17. The method of claim 15, wherein the third resolution is different from the second resolution.

18. The method of claim 14, wherein a device includes in the first processing unit, and wherein the method further comprises:
causing, by the first processing unit, the rendering profile to be transmitted by the device to one or more other devices.

19. A device comprising:
a first processing unit; and
a display processing unit,
wherein the display processing unit is configured to: generate a first frame for display using a first layer generated at a first resolution, wherein the first layer is associated with a first application; generate a second frame not for display using the first layer generated at a second resolution, wherein the first resolution is different from the second resolution; and scale the second frame from the second resolution to the first resolution; and
wherein the first processing unit is configured to: compare the first frame and the scaled second frame; and determine an image quality metric based on the comparison of the first frame and the scaled second frame.

20. The device of claim 19, further comprising a graphics processing unit (GPU), wherein the GPU is configured to generate the first layer at the first resolution.

21. The device of claim 20, wherein the first processing unit is configured to:
detect a trigger event; and
cause the GPU to generate the first layer at the second resolution in response to the trigger event.

22. The device of claim 21, wherein the trigger event comprises an idle event.

23. The device of claim 19, wherein the first processing unit is configured to:
generate a rendering profile based on the image quality metric.

24. The device of claim 23, wherein the first processing unit is configured to:
cause the GPU to generate a second layer at a third resolution based on the rendering profile, wherein the second layer is associated with the first application.

25. An apparatus comprising:
means for generating a first frame for display using a first layer generated at a first resolution, wherein the first layer is associated with a first application;
means for generating a second frame not for display using the first layer generated at a second resolution, wherein the first resolution is different from the second resolution;
means for scaling the second frame from the second resolution to the first resolution;
means for comparing the first frame and the scaled second frame; and
means for determining an image quality metric based on the comparison of the first frame and the scaled second frame.

26. The apparatus of claim 25, further comprising:
means for generating the first layer at the first resolution.

27. The apparatus of claim 26, further comprising:
means for detecting a trigger event; and
means for causing the first layer to be generated at the second resolution in response to the trigger event.

28. The apparatus of claim 27, wherein the trigger event comprises an idle event.

29. The apparatus of claim 25, further comprising:
means for generating a rendering profile based on the image quality metric.

30. The apparatus of claim 29, further comprising:
means for causing a second layer to be generated at a third resolution based on the rendering profile, wherein the second layer is associated with the first application.
